(19) United States
(12) Patent Application Publication
(10) Pub. No.: US 2007/0289146 A1
(43) Pub. Date: Dec. 20, 2007

(54) Hand-held implement for edge-trimming substrate-mounted laminates

(76) Inventor: Lamoyne W. Durham, Saline, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/454,994

(22) Filed: Jun. 16, 2006

(51) Int. Cl. B26B 29/00

(52) U.S. Cl. 30/294; 30/314

(57) ABSTRACT

A hand-held implement for trimming mounted photographs, posters, and other laminates includes a handle, an edge guide connected to the handle defining a side surface for traveling against the peripheral edge of the substrate, and an upper guide connected to the handle defining a lower surface for traveling against the exposed front surface of the laminate. A blade, mounted on the upper guide, has a cutting edge extending below the lower surface of the upper guide and immediately adjacent the side surface of the first guide. When the side surface is stabilized against the peripheral edge of the substrate and pushed forward, the blade produces an edge perfectly matched to the edge of the laminate and an aesthetically pleasing appearance.

### FIELD OF THE INVENTION

This invention relates generally to edge trimming and, in particular, to a hand-held implement for trimming photographs and other materials mounted to substrates, backer boards, and the like.

### BACKGROUND OF THE INVENTION

It is common practice to mount relatively thin sheet material such as photographs, posters, and other graphical and printed matter to thicker or more rigid substrates. For example, photographs are often displayed by mounting them to foam core or Gator boards, which foregoes the need for more expensive framing.

In mounting such materials onto the substrates, it is common practice to use a substrate which is at least slightly smaller than the periphery of the material to be mounted, since registration of a material to be mounted on a substrate of the same size is nearly impossible, particularly when strong, permanent or unforgiving adhesive techniques are used. By using a substrate which is at least slightly smaller in peripheral area than the material to be mounted, the material may be trimmed after mounting, to create a clean edge coextensive with the outline of the substrate.

Unfortunately, it is not always easy to trim a laminate of this type after it has been mounted. Generally the edge of the substrate is used as a guide, and whether a knife or blade is used from the front, or from the back, a straight visually pleasing line is difficult to achieve in practice. If approached from the front, there is no way to see what is happening during the trimming process, and the slightest waviness in the edge is immediately apparent to a critical observer. When cutting from the back, it is impossible to use a roller, since it would have to be butted up against the edge of the substrate, leaving little or no room for the blade. Accordingly, an implement for carrying out such processes would be welcome by those engaged in graphic arts and other fields of endeavor.

### SUMMARY OF THE INVENTION

This invention improves the process of trimming excess laminate extending beyond the peripheral edge of the substrate by providing a hand-held implement having a handle, an edge guide connected to the handle defining a side surface for traveling against the peripheral edge of the substrate, and an upper guide connected to the handle defining a lower surface for traveling against the exposed front surface of the laminate. A blade, mounted on the upper guide, has a cutting edge extending below the lower surface of the upper guide and immediately adjacent the side surface of the first guide.

When the side surface is stabilized against the peripheral edge of the substrate and pushed forward, the blade produces an edge perfectly matched to the edge of the laminate and an aesthetically pleasing appearance.

In the preferred embodiment, the side surface is defined by a flat member configured to slide against the peripheral edge of the substrate, whereas the lower surface is defined by a plurality of rollers. The side surface and the lower surface are generally perpendicular to one another. A blade holder is provided enabling the blade to be replaced. A mechanism allows the adjustment of the proximity of the blade to the edge guide. The side surface preferably includes a leading edge allowing the first guide to travel against the peripheral edge of the substrate before the blade contacts a laminate to be trimmed. The edge and upper guides are spaced apart from the handle to accommodate the excess laminate as it is trimmed.

### BRIEF DESCRIPTION OF THE DRAWING

FIG. 1 is an oblique drawing of the preferred embodiment of the invention, seen from above;

FIG. 2 is a side-view drawing showing the way in which the various guides interact in conjunction with the handle as it is moved forward to cut a laminate mounted to a substrate;

FIG. 3 is an oblique drawing of the preferred embodiment, seen slightly from below, showing the knife edge used for trimming purposes;

FIG. 4 is a drawing which shows the way in which the invention is used to trim a photograph or other laminate, with the blade cover removed to show the blade; and

FIG. 5 is a drawing of the clip used to hold the blade, held in position by the blade cover.

### DETAILED DESCRIPTION OF THE INVENTION

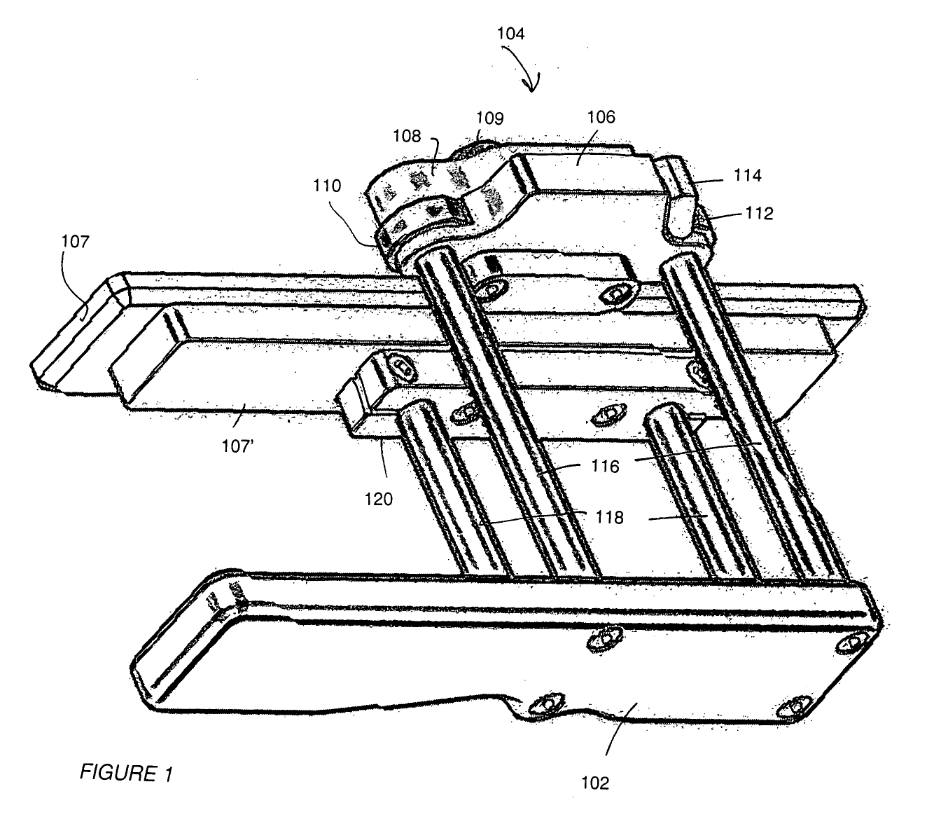

Turning now to the figures, FIG. 1 is an oblique drawing of the preferred embodiment of the invention. The implement includes a handle 102, an upper guide 104 and an edge guide 107. These guides are rigidly connected to the handle through arms 116, 118. In the preferred embodiment, the arms 116, 118 space the handle 102 apart from the guides by a distance of an inch or more, to facilitate the trimming of laminated materials with edge selvedges on the order of up to a few inches.

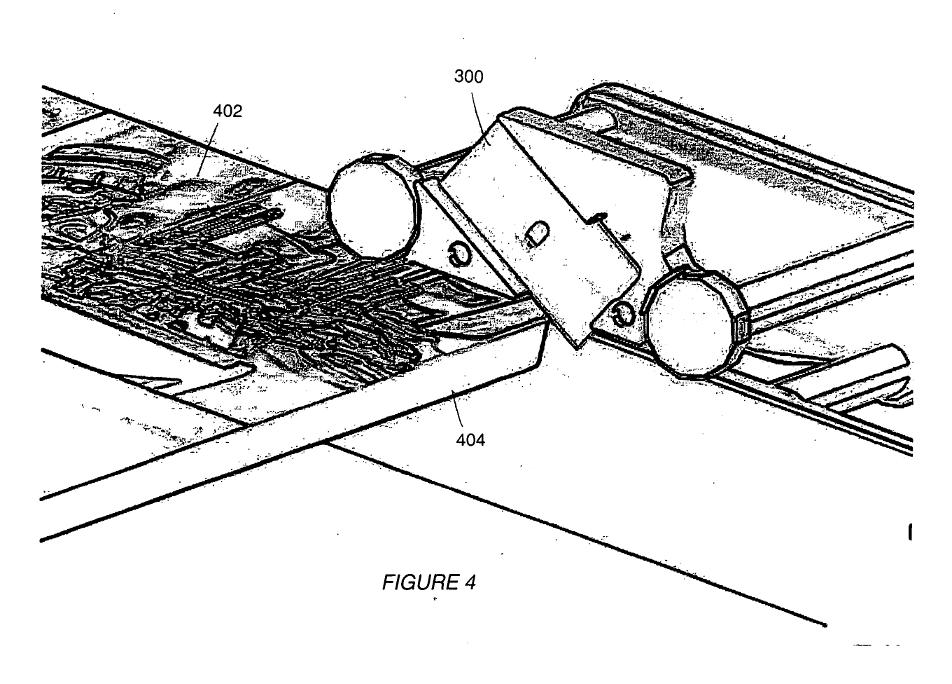

The upper guide 104 is comprised of a roller support 106, which carries rollers 110, 112. The bottom surfaces of the rollers define a lower surface configured for traveling against the exposed front surface of the laminate as it is being trimmed. Note that instead of rollers, a surface could be used to facilitate sliding engagement. The upper guide 104 further includes a blade cover 108 held against the roller support with a knob 109 to expose a blade held by blade clip 114 as shown in FIG. 4. The edge guide 106 is mounted against an edge guide support 108, which includes a rod clamping assembly 120 holding a lower set of rods 118.

In terms of materials, any suitable durable or rigid material may be used. In the preferred embodiment, the implement is constructed mostly of machined metal, aluminum in particular, though rollers 110, 112 and edge guide 107 are preferably constructed from a more slippery material such as nylon, Teflon, or the like. Note that in place of rods 116, 118, bars of material may instead be used, which would preferably be transparent for visualization purposes. Rods 116, 118 are preferred, however, since they still allow for a great degree of visualization while providing a very rigid structure overall. Edge guide 107 is elongated to give the user a few inches of stabilized sliding against the edge of the substrate before and after the mounted laminate is trimmed.

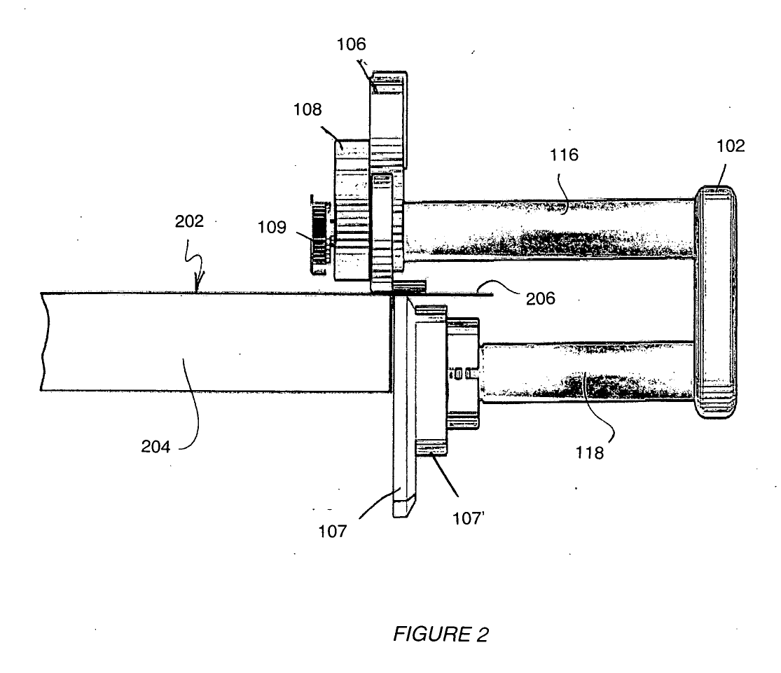

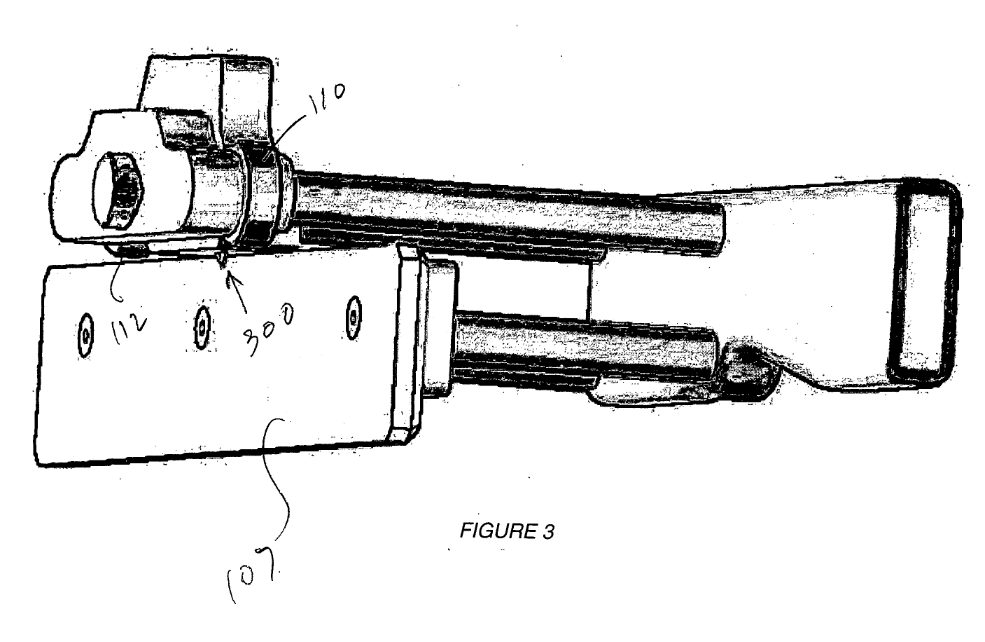

FIG. 2 is a side view drawing showing the way in which the various guides interact in conjunction with the handle as it is moved forward to cut a laminate 202 mounted to a substrate 204. The trimmed laminate is shown at 206. FIG. 3 is an oblique view of a preferred embodiment, as seen from the underside, showing the tip of blade 300. Note that the tip 300 extends slightly below the plane defined by rollers 110, 112, while being immediately adjacent the surface of the edge guide 106.

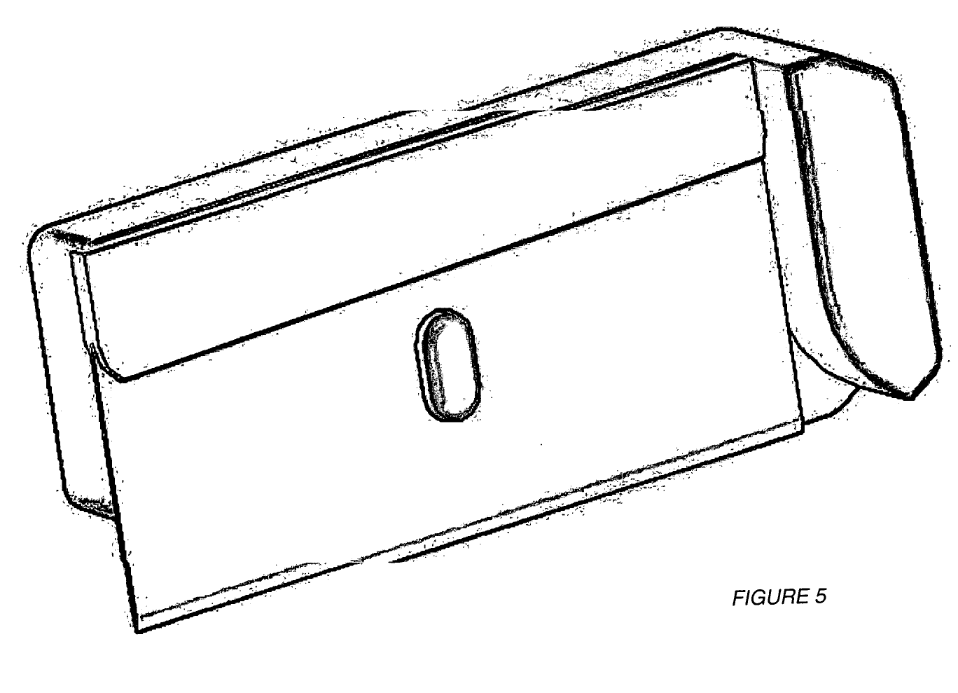

FIG. 4 is a drawing of the preferred embodiment with the blade cover 108 removed, showing the blade 300 beginning to trim a laminate 402 mounted to substrate 404. FIG. 5 is a drawing of the clip 502 used to hold the blade 300, held in position by the blade cover 104. The use of the clip in conjunction with the blade cover allows for the quick interchange of blades with perfect or near-perfect registration during blade interchange. Although in the preferred embodiment a single-edge-injector type blade is used due to its low cost, other clips and blades may be accommodated, including X-Acto® blades, Dexter® blades, and so forth.

I claim:

1. For use with a laminate having an exposed front surface and a back surface mounted to a supporting substrate having a peripheral edge, an implement for trimming excess laminate extending beyond the peripheral edge of the substrate, the implement comprising:
a handle;
an edge guide connected to the handle defining a side surface for traveling against the peripheral edge of the substrate;
an upper guide connected to the handle defining a lower surface for traveling against the exposed front surface of the laminate; and
a blade mounted on the upper guide, the blade having a cutting edge extending below the lower surface of the upper guide and immediately adjacent the side surface of the first guide.

2. The implement of claim 1, wherein the side surface is defined by a flat member configured to slide against the peripheral edge of the substrate.

3. The implement of claim 1, wherein the lower surface is defined by a plurality of rollers.

4. The implement of claim 1, wherein the side surface and the lower surface are generally perpendicular to one another.

5. The implement of claim 1, further including a blade holder enabling the blade to be replaceable.

6. The implement of claim 1, further including a mechanism for adjusting the proximity of the blade to the edge guide.

7. The implement of claim 1, wherein the side surface includes a leading edge allowing the first guide to travel against the peripheral edge of the substrate before the blade contacts a laminate to be trimmed.

8. The implement of claim 1, wherein the side surface includes a trailing edge allowing the first guide to continue traveling against the peripheral edge of the substrate after the blade trims the mounted laminate.

9. The implement of claim 1, wherein the edge and upper guides are spaced apart from the handle to accommodate the excess laminate.

10. The implement of claim 1, wherein:
the blade defines a flat plane; and
the plane of the blade is substantially parallel to the side surface.

11. For use with a laminate having an exposed front surface and a back surface mounted to a supporting substrate having a peripheral edge, an implement for trimming excess laminate extending beyond the peripheral edge of the substrate, the implement comprising:
a handle;
an edge guide connected to the handle including a flat member with a side surface for sliding engagement against the peripheral edge of the substrate;
an upper guide connected to the handle including a plurality of rollers for rolling engagement against the exposed front surface of the laminate; and
a blade mounted on the upper guide, the blade having a cutting edge immediately adjacent the side surface of the edge guide and extending below the back surface of the laminate when the rollers on the upper guide are engaged.

12. The implement of claim 11, wherein the side surface is substantially perpendicular the back surface of the laminate when the rollers are engaged.

13. The implement of claim 11, further including a blade holder enabling the blade to be replaceable.

14. The implement of claim 11, further including a mechanism for adjusting the proximity of the blade to the edge guide.

15. The implement of claim 11, wherein the side surface includes a leading edge allowing the edge guide to slide against the peripheral edge of the substrate before the blade contacts a laminate to be trimmed.

16. The implement of claim 11, wherein the side surface includes a trailing edge allowing the first guide to continue traveling against the peripheral edge of the substrate after the blade trims the mounted laminate.

17. The implement of claim 11, wherein the edge and upper guides are spaced apart from the handle to accommodate the excess laminate.

18. The implement of claim 11, wherein:
the blade defines a flat plane; and
the plane of the blade is substantially parallel to the side surface.
